(19) United States
(12) Patent Application Publication
(10) Pub. No.: US 2024/0100718 A1
(43) Pub. Date: Mar. 28, 2024

(54) Gripping Device, Robot, And Control Method For Gripping Device

(71) Applicant: SEIKO EPSON CORPORATION, Tokyo (JP)

(72) Inventors: Takayuki YONEMURA, Suwa (JP); Takayuki KITAZAWA, Suwa (JP)

(21) Appl. No.: 18/471,548

(22) Filed: Sep. 21, 2023

(30) Foreign Application Priority Data
Sep. 22, 2022 (JP) 2022-151530

(51) Int. Cl. B25J 13/08; B25J 9/16

(52) U.S. Cl. CPC B25J 13/088; B25J 9/1651; B25J 13/082

(57) ABSTRACT

A gripping device includes a gripper gripping an object by decreasing a distance to the object, a pressure sensor provided in the gripper, detecting a contact force applied from the object when contacting with the object, and outputting a detection signal, a driver driving the gripper, and a first controller controlling operation of the driver based on the detection signal, wherein the first controller operates the driver in a first drive mode for decreasing the distance at a first speed when the detection signal is not output, and operates the driver in a second drive mode for decreasing the distance at a second speed lower than the first speed when the detection signal is output.

The present application is based on, and claims priority from JP Application Serial Number 2022-151530, filed Sep. 22, 2022, the disclosure of which is hereby incorporated by reference herein in its entirety.

### BACKGROUND

### 1. Technical Field

The present disclosure relates to a gripping device, a robot, and a control method for a gripping device.

### 2. Related Art

Robots having gripping devices that grip objects in various kinds of work are utilized. The objects desired to be gripped by the gripping devices widely vary. Accordingly, a technique of recognizing a shape of an object desired to be gripped by a camera and determining a gripping motion according to the shape of the object is proposed. However, the technique using the camera requires vast amounts of calculations for recognition of the object and the apparatus may be complex and the cost may be higher.

In order to address the problem, JP-A-2008-183629 discloses a robot including a hand unit having at least two finger portions, contact force measuring means, frequency measuring means, and gripping motion adjusting means. The contact force measuring means measures a contact force applied to the finger portions from an object. The frequency measuring means measures a vibration frequency of the contact force when the finger portions slide along the object surface. The gripping motion adjusting means adjusts a gripping motion of the hand unit gripping the object based on the measured vibration frequency.

According to the configuration, widely varying objects may be gripped without using a camera. In addition, objects with a rough surface and a smooth surface may be distinguished and a gripping force may be determined according to the surface. Thereby, an object with a rough surface is no longer gripped by an excessive gripping force and more appropriate gripping can be realized.

For gripping widely varying objects, a motion (gripping motion) to sufficiently spread the finger portions over the size of an assumed object and then gradually close is necessary. Accordingly, a long time is taken for the finger portions into contact with the object surface and work efficiency may be lower. Particularly, the robot disclosed in JP-A-2008-183629 requires operations to slide the finger portions along the object surface and acquire the vibration frequency, and takes a longer time before completion of gripping work.

On the other hand, if the speed of decreasing the distance between the finger portions is increased, the time taken for the gripping motion may be shortened. However, in this case, the finger portions collide with the object at a higher speed and the object may be damaged. Accordingly, a development of a gripping device that may perform a gripping motion in a shorter time while suppressing a load on an object becomes a challenge.

### SUMMARY

A gripping device according to an application example of the present disclosure includes a gripper gripping an object by decreasing a distance to the object, a pressure sensor provided in the gripper, detecting a contact force applied from the object when contacting with the object, and outputting a detection signal, a driver driving the gripper, and a first controller controlling operation of the driver based on the detection signal, wherein the first controller operates the driver in a first drive mode for decreasing the distance at a first speed when the detection signal is not output, and operates the driver in a second drive mode for decreasing the distance at a second speed lower than the first speed when the detection signal is output.

A robot according to an application example of the present disclosure includes the gripping device according to the application example of the present disclosure, a robot arm to which the gripper is attached, and a second controller controlling operation of the robot arm.

A control method for a gripping device according to an application example of the present disclosure is a method of controlling a gripping device including a gripper gripping an object by decreasing a distance to the object, a pressure sensor provided in the gripper, detecting a contact force applied from the object when contacting with the object, and outputting a detection signal, and a driver driving the gripper, and the method includes operating the driver in a first drive mode for decreasing the distance at a first speed when the detection signal is not output, and operating the driver in a second drive mode for decreasing the distance at a second speed lower than the first speed when the detection signal is output.

### BRIEF DESCRIPTION OF THE DRAWINGS

FIG. 1 is a schematic configuration diagram showing a robot according to an embodiment.

FIG. 2 is a block diagram showing the robot in FIG. 1.

FIG. 3 is an exploded perspective view showing a pressure sensor in FIG. 1.

FIG. 4 is a sectional view of FIG. 3.

FIG. 5 is an enlarged view of a portion B in FIG. 4.

FIG. 6 is a circuit diagram showing a configuration example of a sensor output circuit.

FIG. 7 shows a hardware configuration example of a first controller and a second controller in FIG. 1.

FIG. 8 is a sequence diagram for explanation of a control method for the robot including a control method for a gripping device according to the embodiment.

FIG. 9 is a flowchart for explanation of the control method for the gripping device according to the embodiment.

FIG. 10 is a flowchart for explanation of a control method for the gripping device according to a first modified example.

FIG. 11 is a graphic representation showing relationships between electrical resistance values of pressure-sensitive conductors obtained from sensor output signals and gripping forces corresponding to drive signals output to a driver.

FIG. 12 is a block diagram showing a robot according to a second modified example.

FIG. 13 is a circuit diagram showing a configuration example of a sensor output circuit of a pressure sensor of a gripping device according to a third modified example.

### DESCRIPTION OF EMBODIMENTS

As below, a gripping device, a robot, and a control method for a gripping device will be explained in detail based on embodiments shown in the accompanying drawings.

### 1. Robot

First, a gripping device and a robot according to the embodiment will be explained.

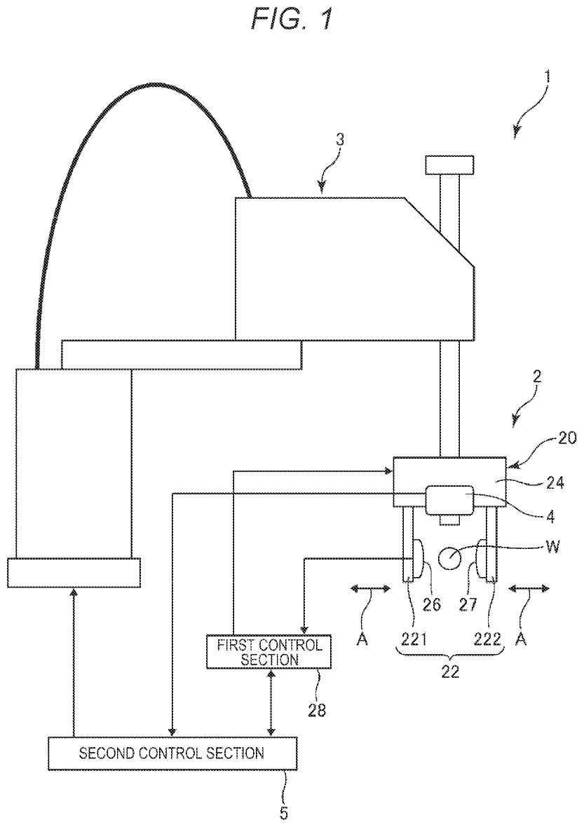

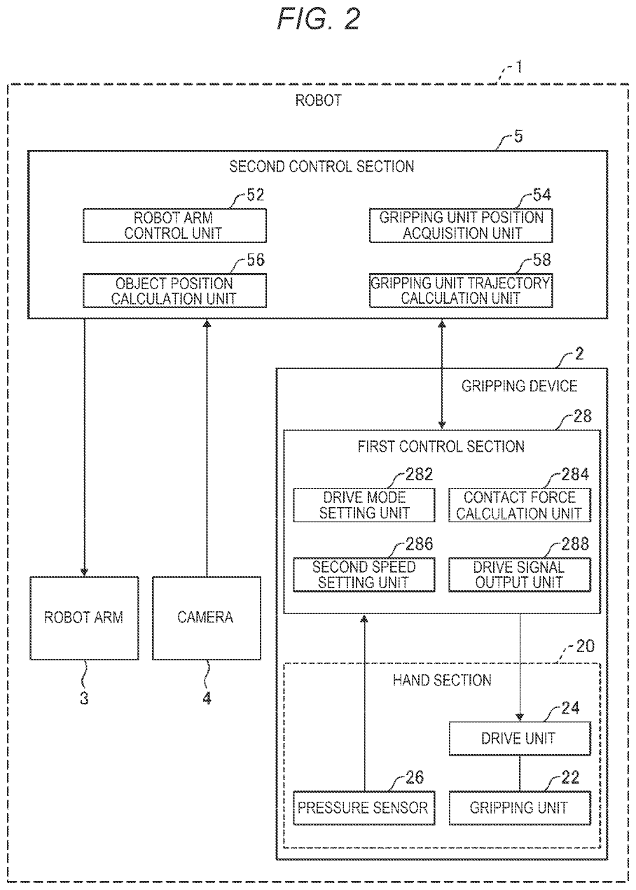

FIG. 1 is a schematic configuration diagram showing a robot 1 according to the embodiment. FIG. 2 is a block diagram showing the robot 1 in FIG. 1.

The robot 1 shown in FIG. 1 includes a gripping device 2, a robot arm 3, a camera 4 (imager), and a second controller 5.

The gripping device 2 includes a hand section 20 and a first controller 28. The hand section 20 includes a gripper 22, a driver 24, a pressure sensor 26, and an opposing portion 27.

The gripper 22 includes a pair of openable and closable finger portions 221, 222 and has a function of gripping an object W by decreasing distances of the finger portions 221, 222 to the object W. The driver 24 drives the gripper 22 to perform a gripping motion. The pressure sensor 26 detects a contact force applied from the object W and outputs a detection signal. The contact force refers to a reaction force applied to the pressure sensor 26 from the object W by driving of the gripper 22 and is output to the detection signal according to the magnitude thereof. Therefore, the contact force can be obtained from the detection signal. The opposing portion 27 is provided in a position opposing to the pressure sensor 26 and sandwiches the object W between the pressure sensor 26 and itself.

The first controller 28 controls operation of the driver 24 based on the detection signal. Further, the first controller 28 has a function of decreasing the distance between the gripper 22 and the object W at a first speed when the detection signal is not output and a function of decreasing the distance between the gripper 22 and the object W at a second speed lower than the first speed when the detection signal is output. Note that, in the specification, “the distance between the gripper 22 and the object W” refers to a distance between the pressure sensor 26 and the center of gravity of the object W.

The gripping device 2 having the above described configuration is configured so that the first controller 28 controls the operation of the driver 24 based on the contact force applied to the pressure sensor 26 from the object W. Accordingly, the griping motion of the object W can be performed without acquisition of the shape of the object W from an image captured by the camera 4. Thereby, the simplification of the configuration and the cost reduction of the gripping device 2 may be realized. Further, the gripping device 2 is configured to drive the gripper 22 at the higher first speed before the gripper 22 contacts the object W and drive the gripper 22 at the lower second speed after the contact. Therefore, the time taken for the gripping motion may be shortened while damage on the object W with the gripping motion is suppressed. As a result, the gripping device 2 having a higher success rate of work and work efficiency may be realized.

### 1.1. Configurations of Respective Parts

The configurations of the respective parts of the robot 1 will be specifically described.

### 1.1.1. Gripping Device

As described above, the gripper 22 shown in FIG. 1 includes the two finger portions 221, 222. The finger portions 221, 222 are driven by the driver 24 to be closer to or away from each other in movement directions A shown in FIG. 1. Thereby, the gripper 22 may nip and grip the object W and release the gripping.

The driver 24 drives the two finger portions 221, 222 to be closer to or away from each other. For example, the driver 24 has a rack-and-pinion mechanism (not shown) and one motor (not shown). The unit has the drive mechanisms, and thereby, may translate the finger portions 221, 222. Note that the drive mechanisms of the driver 24 are not limited to those. For example, the finger portions 221, 222 may be independently translated by two motors. Or, the gripper 22 may open and close the finger portion 221 and the finger portion 222 to change the angle formed by the finger portions.

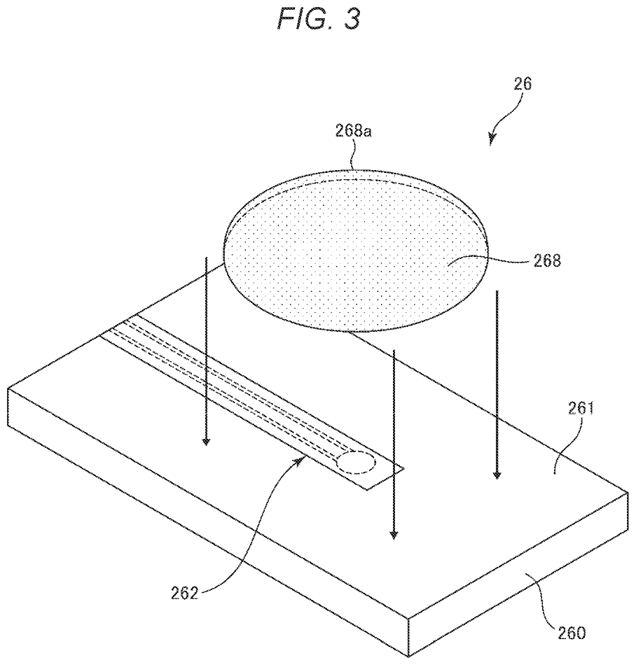

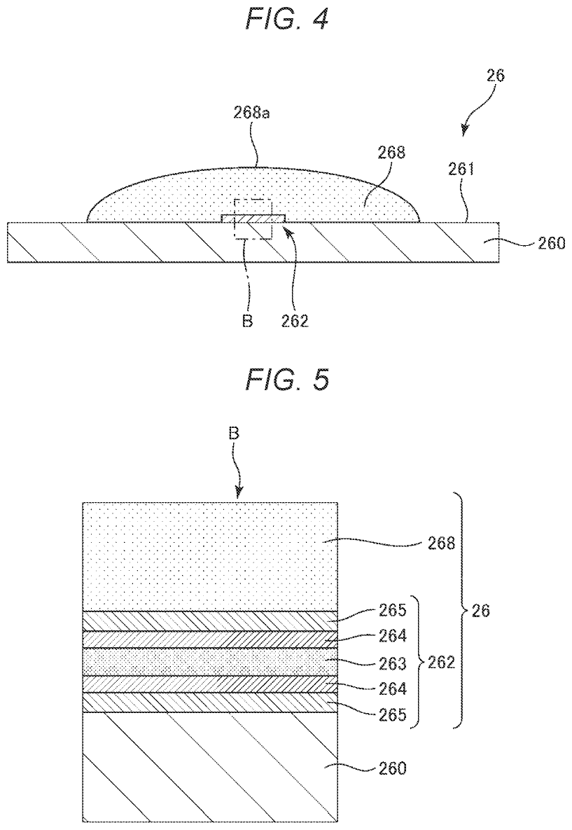

FIG. 3 is an exploded perspective view showing the pressure sensor 26 in FIG. 1. FIG. 4 is a sectional view of FIG. 3. FIG. 5 is an enlarged view of a portion B in FIG. 4.

As shown in FIG. 1, the pressure sensor 26 is attached to the finger portion 221. The pressure sensor 26 shown in FIG. 3 has a base member 260, a pressure-sensitive element 262, and an elastic member 268. The elastic member 268 has elasticity and, when contacting the object W, deforms due to the contact force applied from the object W and propagates the contact force to the pressure-sensitive element 262.

As shown in FIG. 4, the pressure-sensitive element 262 is provided between the base member 260 and the elastic member 268. When the elastic member 268 is deformed, the pressure-sensitive element 262 is pressed and detects the contact force, and thereby, a detection signal is output.

As shown in FIG. 5, the pressure-sensitive element 262 has a pressure-sensitive conductor 263, a pair of electrodes 264, 264, and a pair of insulating sheets 265, 265. The pressure-sensitive element 262 is an element having an electrical resistance value changing when subjected to a change in pressing force. A constituent material of the pressure-sensitive conductor 263 includes e.g., a conductive elastomer and a conductive rubber. Note that the pressure-sensitive element 262 may be an element in which the electrical resistance value of the pressure-sensitive conductor 263 itself changes due to a change in pressing force or an element in which a contact resistance value between the pressure-sensitive conductor 263 and the electrodes 264 changes.

A constituent material of the electrodes 264 includes e.g., a single element or an alloy of Al, Cu, Ni, Ag, Au, or the like. Wires (not shown) are coupled to the pair of electrodes 264, 264. The wires couple the pair of electrodes 264, 264 and the first controller 28.

The base member 260 has a mounting surface 261. The base member 260 includes e.g., a resin film, a resin substrate, and a ceramic substrate.

The elastic member 268 has elasticity and is placed on the mounting surface 261 to cover the pressure sensor 26. The elasticity refers to a property of deforming according to a force when the force is applied and returning to the original shape when the force is removed. Therefore, when a force is applied to the elastic member 268, the elastic member 268 deforms and the force is propagated.

Further, as shown in FIG. 4, it is preferable that the elastic member 268 has a convex curved surface 268a. The convex curved surface 268a is a spherical or an aspherical curved surface projecting in a direction away from the mounting surface 261, i.e., a direction from the finger portion 221 toward the finger portion 222. Note that the shape of the convex curved surface 268a is not particularly limited. With the convex curved surface 268a, when the elastic member 268 contacts the object W, the top portion of the convex curved surface 268a preferentially contacts. Thereby, the contact force applied to the elastic member 268 from the object W may be efficiently propagated to the pressure-sensitive element 262. As a result, sensitivity and accuracy of the pressure sensor 26 may be further increased.

In the specification, the shape of the object having the convex curved surface 268a is referred to as “dome shape”. The elastic member having the dome shape has a property of efficiently propagating the contact force as described above, and is useful as the elastic member 268 used for the pressure sensor 26.

A constituent material of the elastic member 268 includes e.g., rubber, elastomer, and foam resin. Of the materials, the rubber includes e.g., polyisobutylene, polyisoprene, chloroprene rubber, butyl rubber, silicone rubber, fluoro-rubber, acrylic rubber, urethane rubber, ethylene-propylene rubber, butadiene rubber, acrylonitrile butadiene rubber, and styrene-butadiene rubber.

As shown in FIG. 2, the first controller 28 has a drive mode setting unit 282, a contact force calculation unit 284, a second speed setting unit 286, and a drive signal output unit 288 as functional units.

The drive mode setting unit 282 has a function of setting a mode (drive mode) for control of the operation of the driver 24. The drive mode includes e.g., a first drive mode and a second drive mode. The first drive mode is a drive mode for operating the driver 24 to decrease the distance between the gripper 22 and the object W at the first speed. The second drive mode is a drive mode for operating the driver 24 to decrease the distance between the gripper 22 and the object W at the second speed lower than the first speed.

The drive mode setting unit 282 has a function of operating the driver 24 in the first drive mode when the detection signal is not output from the pressure sensor 26. Further, the drive mode setting unit 282 has a function of operating the driver 24 in the second drive mode when the detection signal is output from the pressure sensor 26.

The contact force calculation unit 284 analog/digital-converts the sensor output signal output from the pressure sensor 26, and then, calculates magnitude of the contact force applied to the pressure sensor 26 from the object W based on the obtained signal (detection signal). Note that the magnitude of the contact force may take an absolute value in an arbitrary unit or a relative value to a reference value. Further, the detection signal may be a signal obtained by digital conversion of the sensor output signal output from the pressure sensor 26 or a signal obtained by arbitrary processing or the like on the digitally-converted signal.

Note that, when the magnitude of the contact force is calculated from the detection signal, the magnitude may be calculated based on a result of a past performance, an experiment, a simulation, or the like.

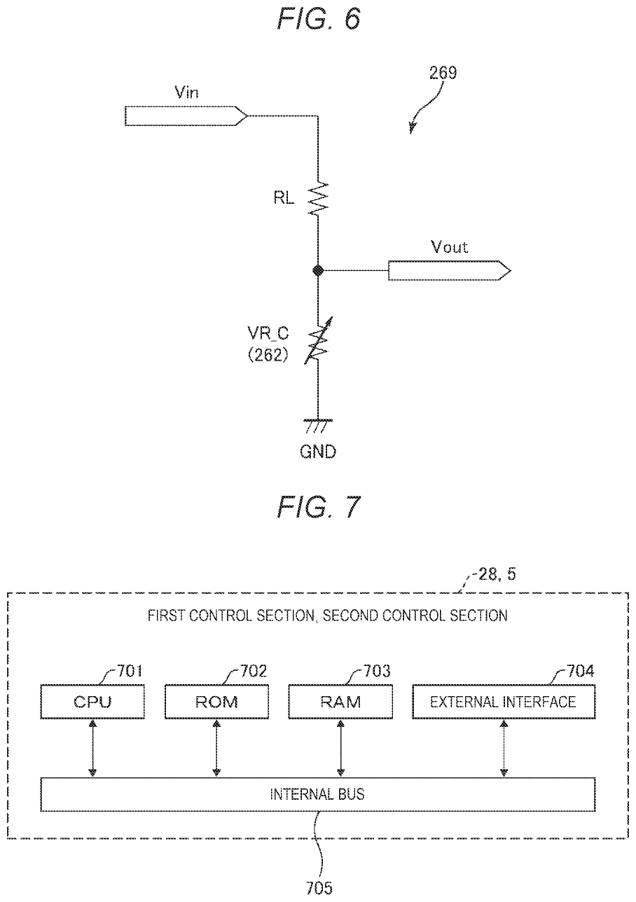

Alternatively, the pressure sensor 26 may have a sensor output circuit 269 shown in FIG. 6. FIG. 6 is a circuit diagram showing a configuration example of the sensor output circuit 269.

The sensor output circuit 269 has a fixed resistor RL and a pressure-sensitive element resistor VR_C corresponding to the pressure-sensitive element 262. The fixed resistor RL is a resistor element having a fixed electrical resistance value. The pressure-sensitive element resistor VR_C is a resistor element having an electrical resistance value changing according to the force applied to the pressure-sensitive element 262. The fixed resistor RL and the pressure-sensitive element resistor VR_C are sequentially series-coupled between a sensor power supply voltage Vin and a ground GND. A sensor output signal Vout is output from between the fixed resistor RL and the pressure-sensitive element resistor VR_C.

In the sensor output circuit 269, the sensor output signal Vout is obtained based on the following expression

Vout=VR_C/(RL+VR_C)×Vin.

The intensity of the obtained sensor output signal Vout corresponds to the electrical resistance value of each pressure-sensitive element 262.

Note that, in the sensor output circuit 269, an arbitrary element may be added or replaced as necessary to the circuit configuration shown in FIG. 6.

The second speed setting unit 286 sets the second speed when the driver 24 is operated in the second drive mode. The second speed is not particularly limited as long as it is lower than the first speed, but may be set to a predetermined value in advance. When the material and the property of the object W are known, the predetermined value may be selected according thereto. The second speed corresponds to a gripping force when the object W is gripped. Accordingly, the object W may be gripped with a gripping force suitable for the property of the object W by optimization of the second speed by the second speed setting unit 286. Thereby, damage on the object W may be suppressed more reliably.

Alternatively, the second speed setting unit 286 may have a function of setting the second speed based on the magnitude of the contact force. According to the function, the second speed determined in advance may be optimized according to the magnitude of the contact force. Thereby, even when the properties or the like of the objects W are individually different, the gripping forces may be optimized and the success rate of work and the work efficiency may be further increased.

Note that the second drive mode is the drive mode for operating the driver 24 to decrease the distance between the gripper 22 and the object W at the second speed lower than the first speed, and effectively works even after the gripper 22 contacts the object W. Specifically, even after the gripper 22 contacts the object W, while the object W is deformable, the distance between the gripper 22 and the object W continues to decrease. In this case, the distance may be decreased at the second speed. However, when the object W is compressed and becomes undeformable, it may be difficult to decrease the distance. The second drive mode includes a case where the gripper 22 continues to press the object W with the gripping force corresponding to the second speed even when the object W is in an undeformable state. That is, the above described “decrease at the second speed” includes the meaning “intend to decrease at the second speed”. Thereby, the gripping force may be optimized even when the object W is in the undeformable state. Note that the second speed is lower than the first speed, and the gripping force corresponding to the second speed is smaller than the gripping force corresponding to the first speed.

The drive signal output unit 288 outputs a drive signal to the driver 24 based on the drive mode set by the drive mode setting unit 282. For example, the drive signal output unit 288 outputs electric power (drive signal) to the driver 24 by switching control. The system of the switching control includes e.g., PWM (Pulse Width Modulation) control and VFM (Variable Frequency Modulation) control. Of the control systems, the PWM control is preferably used. The PWM control is readily available because the control is easier and conversion efficiency from an input voltage to an output voltage is higher.

FIG. 7 shows a hardware configuration example of the first controller 28 in FIG. 1.

The functions exerted by the respective functional units of the first controller 28 are realized by hardware including e.g., a CPU 701, a ROM 702, a RAM 703, an external interface 704, and an internal bus 705 shown in FIG. 7. The CPU 701, the ROM 702, the RAM 703, and the external interface 704 can communicate with one another via the internal bus 705.

The CPU 701 is a central processing unit. Note that the CPU 701 may be a DSP (Digital Signal Processor). Further, all or part of the hardware shown in FIG. 7 may be formed by an FPGA (Field-Programmable Gate Array), an ASIC (Application Specific Integrated Circuit), or the like.

The RAM 702 is a read-only memory and formed by an arbitrary non-volatile memory element. The ROM 703 is a random access memory and formed by an arbitrary volatile memory element.

The external interface 704 includes e.g., a digital input/output port such as a USB (Universal Serial Bus) or an RS-232C, an analog input/output port, and an Ethernet (registered trademark) port.

The opposing portion 27 is the same member as the elastic member 268. The object W is sandwiched between the pressure sensor 26 and the opposing portion 27, subjected to the gripping force, and gripped. Note that the opposing portion 27 may be the same member as the pressure sensor 26. That is, the opposing portion 27 may have the pressure-sensitive element 262.

### 1.1.2. Robot Arm

The robot arm 3 shown in FIG. 1 is an arm for a horizontal articulated robot. The hand section 20 is attached to the robot arm 3. Thereby, the robot arm 3 may change the position and the attitude of the hand section 20. In the horizontal articulated robot, the pivot plane of the arm is horizontal and the pivot speed is easily increased. Accordingly, the horizontal articulated robot is used, and thereby, the position and the attitude of the hand section 20 may be quickly changed and the work efficiency by the gripping device 2 may be increased. Note that the form of the robot arm 3 is not limited to that, but may be an arm for a vertical articulated robot.

### 1.1.3. Camera

The camera 4 images the object W and transmits the captured image to the second controller 5. As will be described later, the second controller 5 controls the motion of the robot arm 3 based on the acquired image. Thereby, the gripper 22 may be moved according to the position of the object W.

Note that the camera 4 may be a color camera or a monochrome camera as long as the camera can image the outer shape of the object W. Or, the camera 4 may be replaced by another sensor that can detect the position of the object W.

### 1.1.4. Second Controller

The second controller 5 has a robot arm control unit 52, a gripper position acquisition unit 54, an object position calculation unit 56, and a gripper trajectory calculation unit 58 as functional units.

The robot arm control unit 52 controls the motion of the robot arm 3. Thereby, the hand section 20 may be moved to target position and attitude.

The gripper position acquisition unit 54 acquires the position of the gripper 22 based on the motion status of the robot arm 3.

The object position calculation unit 56 acquires the image captured by the camera 4. Then, the position of the object W is calculated from the acquired image. Note that the position of the object W has a concept as a range occupied by the object W on the image or a concept as a position of the gravity center of the object W on the image. In the latter case, the amount of calculation and the time taken for the calculation may be reduced and the resource necessary for the second controller 5 may be reduced. Further, it is also effective that the inexpensive, compact, and lightweight camera 4 may be used because high quality is not required for the image. Note that, in the embodiment, it is not necessary to strictly calculate the position and the shape of the object W in the gripping motion in the first place, and the simplification and the cost reduction of the resource and the camera 4 necessary for the second controller 5 may be easily realized.

The gripper trajectory calculation unit 58 calculates a trajectory in which the gripper 22 is moved based on the position of the object W calculated by the object position calculation unit 56 and the position of the gripper 22 acquired by the gripper position acquisition unit 54. The above described robot arm control unit 52 moves the gripper 22 along the trajectory.

FIG. 7 shows a hardware configuration example of the second controller 5 in FIG. 1.

The functions exerted by the respective functional units of the second controller 5 are realized by hardware including e.g., a CPU 701, a ROM 702, a RAM 703, an external interface 704, and an internal bus 705 shown in FIG. 7. The CPU 701, the ROM 702, the RAM 703, and the external interface 704 can communicate with one another via the internal bus 705.

As above, the configurations of the respective parts of the robot 1 are explained. In the embodiment, the first controller 28 mainly controls the motion of the hand section 20. That is, in the first controller 28, analog/digital conversion of the sensor output signal, feedback processing to the driver 24 based on the contact force, and opening and closing processing of the gripper 22 are controlled. In this manner, in the first controller 28, external communication with the second controller 5 may be suppressed to the minimum necessary and shifts in processing timing may be suppressed and the amount of calculation may be reduced. As a result, the higher processing speed and the higher reliability in the first controller 28 may be realized.

On the other hand, the second controller 5 controls the respective operations of the robot arm 3, the camera 4, and the first controller 28. That is, the processing performed by the first controller 28 is separated from the second controller 5. Accordingly, the necessary resource may be reduced in the second controller 5.

Note that, in the embodiment, the first controller 28 and the second controller 5 are realized by the separate hardware from each other, however, these sections may be realized by single hardware. That is, the first controller 28 and the second controller 5 may be integrated in one controller.

### 1.2. Control Method for Robot

Next, a control method for the robot 1 including a control method for the gripping device according to the embodiment will be explained.

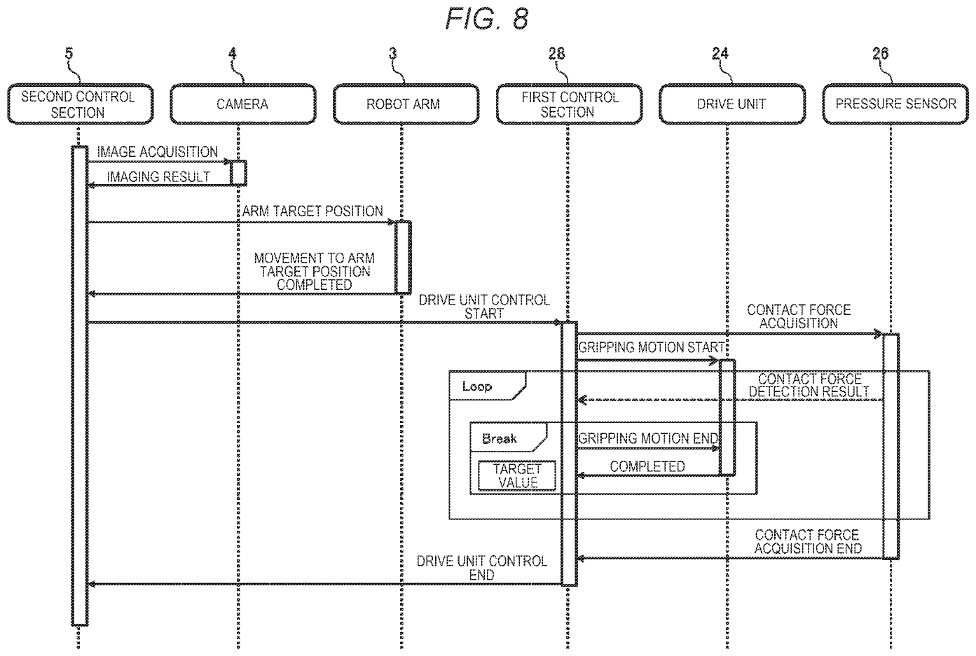

FIG. 8 is a sequence diagram for explanation of the control method for the robot 1 including the control method for the gripping device according to the embodiment.

In the sequence diagram shown in FIG. 8, the component elements of the robot 1 are arranged along the horizontal axis. Further, the vertical axis indicates time.

First, the second controller 5 outputs a command for image acquisition toward the camera 4. Thereby, the camera 4 performs imaging of the object W and outputs an imaging result to the second controller 5. Then, the second controller 5 acquires an image of the object W.

Then, the second controller 5 outputs a command for a target position (arm target position) toward the robot arm 3 based on the position of the object W and the position of the gripper 22. Thereby, the robot arm 3 moves the gripper 22 to the target position, i.e., the present position of the object W. As a result, a preparation for the start of the gripping motion of the object W by the gripper 22 is completed.

Then, the second controller 5 outputs a command to start the control of the driver 24 toward the first controller 28. Thereby, the first controller 28 starts detection of the contact force by the pressure sensor 26 and acquires the detection result of the contact force. Further, in parallel, the first controller 28 starts driving of the gripper 22 by the driver 24. Here, an example of the operation to continue driving until the contact force becomes the target value is shown. That is, the detection of the contact force and the driving of the gripper 22 are repeated until the contact force becomes the target value. Then, when the contact force reaches the target value, the repetition is ended. Then, the first controller 28 ends the acquisition of the contact force. Further, the second controller 5 ends the control of the driver 24 by the first controller 28. In this manner, the gripping motion is completed.

### 1.3. Control Method for Gripping Device

Next, of the control method for the robot 1 shown in FIG. 8, the control method for the gripping device 2 will be specifically described.

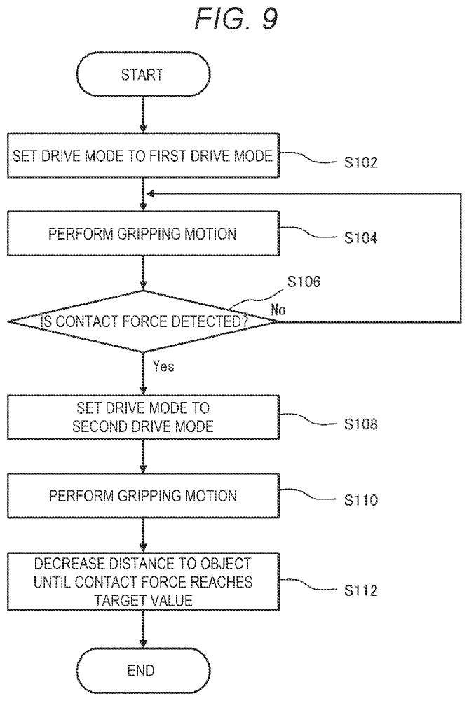

FIG. 9 is a flowchart for explanation of the control method for the gripping device according to the embodiment.

The control method for the gripping device according to the embodiment has step S102 to step S112 shown in FIG. 9. As below, the respective steps will be explained.

At step S102, the drive mode setting unit 282 of the first controller 28 sets the drive mode to the first drive mode. In the first drive mode, the distance between the gripper 22 and the object W is decreased at the first speed higher than that in the second drive mode.

At step S104, the drive signal output unit 288 controls the gripper 22 to perform the gripping motion in the first drive mode. Specifically, first, the distance between the finger portions 221, 222 is increased to a width estimated to be sufficiently wider than the size of the object W. Note that the initial distance between the finger portions 221, 222 may be set based on the image captured by the camera 4 as necessary. Then, the distance between the gripper 22 and the object W is decreased at the first speed by the driver 24.

According to the step S104, even when the object W widely varies, the gripping motion can be performed without relying on the shape recognition of the object W by image processing. That is, the distance between the finger portions 221, 222 is decreased from the distance sufficiently wider than the object W, and the object W may be gripped by the gripper 22 regardless of the shape and the size as long as the object W may have the width within the distance.

At step S106, the drive mode setting unit 282 monitors the contact force applied to the pressure sensor 26 from the object W. When the contact force is not detected, the process returns to step S104 and the gripping motion is continued. That is, continuously, the operation of the driver 24 is controlled to decrease the distance between the gripper 22 and the object W at the first speed. On the other hand, when the contact force is detected, that is, the pressure sensor 26 contacts the object W, the process goes to step S108.

According to the step S106, the first speed may be set to a higher value and the gripper 22 may be driven at the first speed after the start of the gripping motion to the detection of the contact force. Accordingly, the time taken to decrease the distance between the gripper 22 and the object W may be shortened and the work efficiency may be increased.

Note that the detection of the contact force refers to acquisition of the sensor output signal by which contact may be assumed. For example, some pressure-sensitive signal may be output even when the gripper 22 does not contact the object W depending on the type of the pressure sensor 26. The sensor output signal by which contact may be assumed does not include that signal.

At step S108, the drive mode setting unit 282 sets the drive mode to the second drive mode. In the second drive mode, the distance between the gripper 22 and the object W is decreased at the second speed lower than that in the first drive mode.

At step S110, the drive signal output unit 288 controls the gripper 22 to perform the gripping motion in the second drive mode. Specifically, the distance between the gripper 22 and the object W is decreased at the second speed by the driver 24. The gripping force generated at the second speed takes a smaller value and the gripping force applied to the object W by the gripper 22 may be made smaller. Thereby, damage on the object W with the gripping motion may be suppressed.

Note that the drive mode may be changed by changing of the waveform of the drive signal output to the driver 24 by the drive signal output unit 288. For example, when the switching control system of the drive signal output unit 288 is the PWM control, the movement speeds of the finger portions 221, 222, i.e., the speeds in the respective drive modes may be easily changed by changing of the duty ratios of the drive signals.

At step S112, the gripping motion by the gripper 22 is continued until the contact force reaches the target value. When the contact force reaches the target value, driving of the gripper 22 by the driver 24 is ended. Thereby, the object W gripped by the gripper 22 may be kept. That is, gripping of the object W is completed. Note that, as the target value of the contact force, a value set through a past performance, an experiment, a simulation, or the like may be employed.

### 2. First Modified Example

Next, as a first modified example, a modified example of the above described control method for the gripping device will be explained.

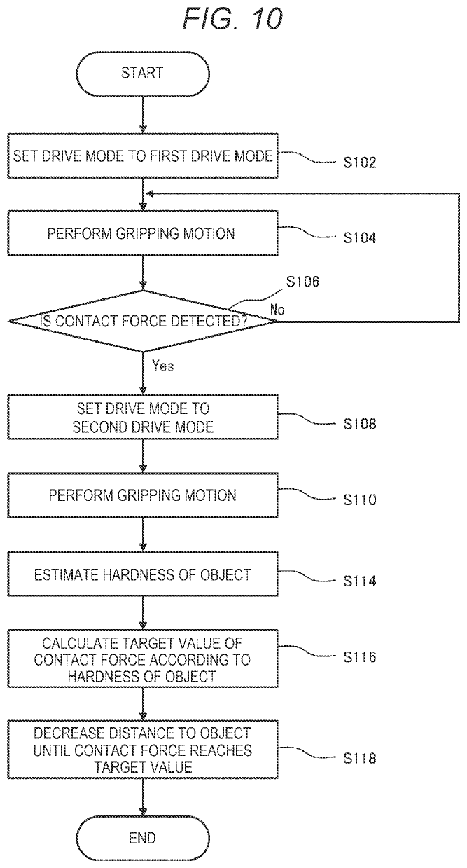

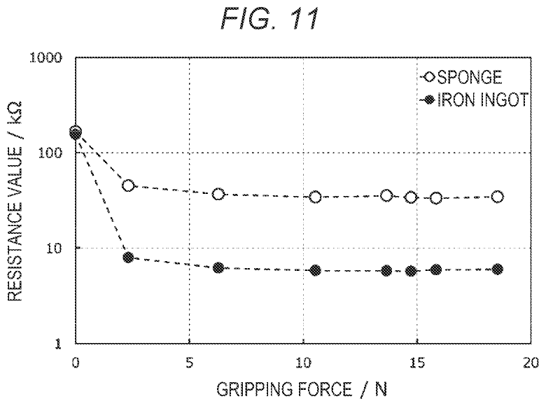

FIG. 10 is a flowchart for explanation of the control method for the gripping device according to the first modified example. FIG. 11 is a graphic representation for explanation of the control method for the gripping device shown in FIG. 10 and showing relationships between electrical resistance values of the pressure-sensitive conductors 263 obtained from sensor output signals and gripping forces corresponding to drive signals output to the driver 24.

As below, the first modified example will be explained with a focus on differences from the above described embodiment and the explanation of the same items will be omitted. In FIG. 10, the same configurations as those of the above described embodiment have the same signs.

The control method for the gripping device according to the first modified example is the same as the control method for the gripping device according to the above described embodiment except that hardness of the object W is estimated from the magnitude of the contact force and the target value of the contact force is set based thereon.

The control method for the gripping device according to the first modified example has step S102 to step S118 shown in FIG. 10. As below, the respective steps will be explained.

Step S102 to step S110 are the same as those of the above described embodiment.

At step S114, the hardness of the object W is estimated based on the magnitude of the contact force detected by the pressure sensor 26. The hardness of the object W is a property corresponding to resistance to deformation different from surface hardness. To stably grip the object W, adjustment of the gripping force in consideration of the hardness of the object W is effective.

FIG. 11 is the graphic representation created by plotting obtained data with the gripping force on the horizontal axis and the electrical resistance values obtained based on the sensor output signals from the pressure-sensitive conductor 263 on the vertical axis. In FIG. 11, a graph of a case where the object W is a sponge and a graph of a case where the object W is an iron ingot are shown.

As shown in FIG. 11, the electrical resistance value of the pressure-sensitive conductor 263 gradually decreases when the gripping force is increased from zero. Here, the rate of decrease in the case where the object W is an iron ingot is higher than the rate of decrease in the case where the object W is a sponge. Further, both of the two graphs shown in FIG. 11 converge to nearly constant electrical resistance values. It is considered that the converged value reflects the hardness of the object W. Therefore, the contact force calculation unit 284 of the first controller 28 may estimate the hardness of the object W. That is, the contact force calculation unit 284 may have not only the function of calculating the magnitude of the contact force from the sensor output signal but also a function of estimating the hardness of the object W.

Note that, when the hardness of the object W is estimated from the magnitude of the contact force, the hardness may be estimated based on a result of a past performance, an experiment, a simulation, or the like.

At step S116, the second speed setting unit 286 of the first controller 28 calculates the target value of the contact force according to the hardness of the object W. The target value is obtained by updating of the initial target value according to the estimated hardness of the object W. Note that, as the target value of the contact force according to the hardness of the object W, a value set through a past performance, an experiment, a simulation, or the like may be employed. Then, the second speed setting unit 286 updates the second speed in the second drive mode according to the updated target value.

At step S118, the distance between the gripper 22 and the object W is decreased at the second speed until the detected contact force reaches the updated target value. Then, when the contact force reaches the updated target value, driving without change is held. Or, when the gripping force may be kept by holding torque by a reduction ratio of a motor, driving of the gripper 22 by the driver 24 may be ended. Thereby, the object W may be gripped with the gripping force optimized according to the hardness thereof. As a result, probabilities that the object W is damaged by an excessively large gripping force and the gripped object W is dropped by deformation of the object W may be reduced.

In the first modified example, the same effects as those of the above described embodiment may be obtained.

### 3. Second Modified Example

Next, as a second modified example, a modified example of the above described robot will be explained.

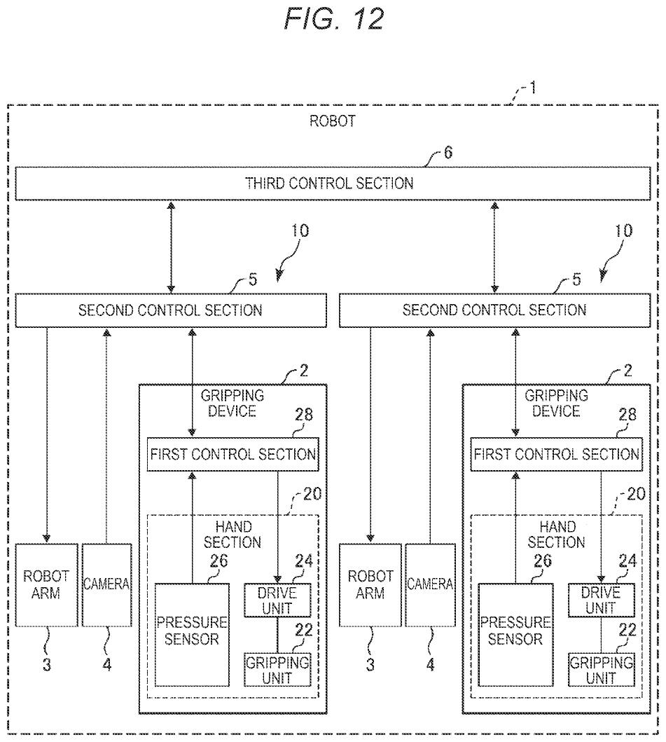

FIG. 12 is a block diagram showing a robot 1 according to the second modified example.

As below, the second modified example will be explained with a focus on differences from the above described embodiment and the explanation of the same items will be omitted. In FIG. 12, the same configurations as those of the above described embodiment have the same signs.

The robot 1 according to the second modified example is the same as the robot 1 according to the embodiment except that two units 10 each including the gripping device 2, the robot arm 3, the camera 4, and the second controller 5 are provided and a third controller 6 controlling operation of the two units 10 is provided.

The units 10 respectively independently operate. Accordingly, the two robot arms 3 may be controlled to perform not only the same work as each other but also different work from each other. Thereby, the work efficiency of the robot 1 may be further increased.

The third controller 6 is a high-level controller controlling the operation of the two second controllers 5. The third controller 6 is provided and the two units 10 may be cooperatively operated. Thereby, work in cooperation of the two robot arms 3 may be performed and the range of work that can be performed may be increased (the number of types of work may be increased). Note that the number of the units 10 may be three or more.

In the second modified example, the same effects as those of the above described embodiment may be obtained.

### 4. Third Modified Example

Next, as a third modified example, a modified example of the above described gripping device will be explained.

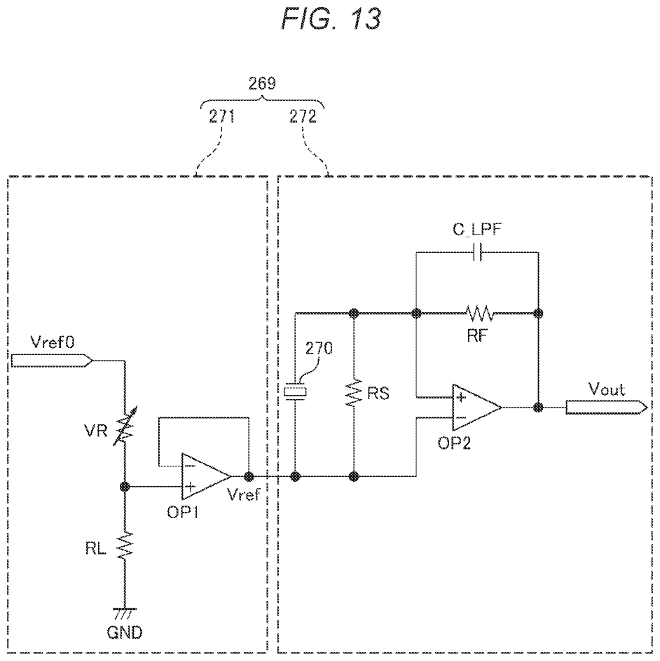

FIG. 13 is a circuit diagram showing a configuration example of a sensor output circuit 269 of a pressure sensor of a gripping device according to the third modified example.

As below, the third modified example will be explained with a focus on differences from the above described embodiment and the explanation of the same items will be omitted. In FIG. 13, the same configurations as those of the above described embodiment have the same signs.

The gripping device according to the third modified example is the same as the gripping device 2 according to the embodiment except that the pressure sensing principle of the pressure sensor 26 is different.

In the third modified example, the pressure sensor 26 has a piezoelectric element 270 shown in FIG. 13. In the pressure sensor 26 having the piezoelectric element 270, a signal output using the piezoelectric effect is the sensor output signal.

The piezoelectric element 270 includes a piezoelectric body and a pair of electrodes provided via the piezoelectric material (not shown). The piezoelectric body generates a voltage between the electrodes by the piezoelectric effect, for example, when pressure is applied thereto.

A piezoelectric material forming the piezoelectric body includes e.g., piezoelectric ceramics such as lead zirconate titanate (PZT), barium titanate, and lead titanate and piezoelectric plastic such as polyvinylidene fluoride and polylactic acid.

The sensor output circuit 269 shown in FIG. 13 has the piezoelectric element 270, a reference voltage generation unit 271, and a signal amplification unit 272. The reference voltage generation unit 271 has a variable resistor VR, a fixed resistor RL, and an operational amplifier OP1. The signal amplification unit 272 has a resistor RS, a resistor RF, a capacitor C LPF, and an operational amplifier OP2.

In the reference voltage generation unit 271, an input reference original voltage Vref0 is divided by the variable resistor VR and the fixed resistor RL and output via the operational amplifier OP1, and thereby, a reference voltage Vref is generated. The generated reference voltage Vref is input to the signal amplification unit 272. The reference voltage Vref is calculated based on the following expression

Vref=RL/(VR+RL)×Vref0.

The signal amplification unit 272 has a charge amplifier, and converts a charge signal output from the piezoelectric element 270 into a voltage signal and outputs the voltage signal. The voltage signal is the sensor output signal Vout.

The sensor output signal Vout is calculated based on the following expression

Vout=−η×(dP/dt)×RF+Vref.

Note that, in the above described expression, P is pressure applied to the pressure sensor 26, η is a charge generation efficiency coefficient for the pressure, and t is time.

Further, in the sensor output circuit 269, an arbitrary element may be added or replaced as necessary to the circuit configuration shown in FIG. 13.

In the third modified example, the same effects as those of the above described embodiment may be obtained.

### 5. Effects Exerted by Embodiment and Respective Modified Examples

As described above, the gripping device 2 according to the above described embodiment and respective modified examples includes the gripper 22, the pressure sensor 26, the driver 24, and the first controller 28. The gripper 22 grips the object W by decreasing the distance to the object W. The pressure sensor 26 is provided in the gripper 22, and detects the contact force applied from the object W when contacting with the object W and outputs the detection signal. The driver 24 drives the gripper 22. The first controller 28 controls the operation of the driver 24 based on the detection signal.

When the detection signal is not output, the first controller 28 operates the driver 24 in the first drive mode and, when the detection signal is output, operates the driver 24 in the second drive mode. The first drive mode is the drive mode for operating the driver 24 to decrease the above described distance at the first speed, and the second drive mode is the drive mode for operating the driver 24 to decrease the above described distance at the second speed lower than the first speed.

According to the gripping device 2, the time taken for the gripping motion may be shortened while damage on the object W with the gripping motion is suppressed. Thereby, the work efficiency by the robot 1 including the gripping device 2 may be increased. Further, the gripping motion may be performed without relying on the shape recognition of the object W by image processing, and the simplification of the configuration and the cost reduction of the robot 1 may be easily realized.

Further, the first controller 28 may have a function of calculating the magnitude of the contact force from the detection signal and setting the second speed based on the calculated magnitude of the contact force.

According to the configuration, the gripping device 2 may grip the object W with the gripping force suitable for the property of the object W. Thereby, damage on the object W may be suppressed more reliably.

Further, the first controller 28 may have a function of controlling the operation of the driver 24 by changing the waveform of the drive signal output to the driver 24.

According to the configuration, for example, when the switching control system of the drive signal output unit 288 is the PWM control, the speeds in the respective drive modes may be easily changed by changing of the duty ratios of the drive signals.

The pressure sensor 26 has the pressure-sensitive element 262 and the elastic member 268. The pressure-sensitive element 262 outputs a detection signal by being pressed. The elastic member 268 is placed to cover the pressure-sensitive element 262 and has the dome shape.

According to the configuration, the pressure sensor 26 efficiently propagates the contact force applied to the elastic member 268 from the object W to the pressure-sensitive element 262. Thereby, the sensitivity of the pressure sensor 26 may be further increased.

The robot 1 according to the above described embodiment or the respective modified examples includes the above described gripping device 2, the robot arm 3, and the second controller 5. The gripper 22 is attached to the robot arm 3. The second controller 5 controls the operation of the robot arm 3.

According to the robot 1, the time taken for the gripping motion may be shortened while damage on the object W with the gripping motion is suppressed. Thereby, the work efficiency by the robot 1 may be increased. Further, the gripping motion may be performed without relying on the shape recognition of the object W by image processing, and the simplification of the configuration and the cost reduction of the robot 1 may be easily realized.

The robot 1 may include the camera 4 (imager) imaging the object W. Further, the second controller 5 calculates the position of the object W from the image acquired by the camera 4 and calculates the trajectory in which the gripper 22 is moved based on the position of the object W and the position of the gripper 22.

According to the robot 1, in the second controller 5, the position of the object W is calculated from the image and image processing with a heavy load is not necessary. Further, the trajectory of the gripper 22 is calculated by the second controller 5. Thereby, the resource necessary for the first controller 28 may be reduced. As a result, in the first controller 28, external communication with the second controller 5 may be suppressed to the minimum necessary and shifts in processing timing may be suppressed and the amount of calculation may be reduced. As a result, the higher processing speed and the higher reliability in the first controller 28 may be realized.

The control method for the gripping device according to the above described embodiment or the respective modified examples is the method of controlling the gripping device 2 including the gripper 22, the pressure sensor 26, and the driver 24. The gripper 22 grips the object W by decreasing the distance to the object W. The pressure sensor 26 is provided in the gripper 22, and detects the contact force applied from the object W when contacting with the object W and outputs the detection signal. The driver 24 drives the gripper 22.

In the control method for the gripping device 2, when the detection signal is not output, the driver 24 is operated in the first drive mode and, when the detection signal is output, the driver 24 is operated in the second drive mode. The first drive mode is the drive mode for operating the driver 24 to decrease the above described distance at the first speed, and the second drive mode is the drive mode for operating the driver 24 to decrease the above described distance at the second speed lower than the first speed.

According to the control method for the gripping device, the time taken for the gripping motion may be shortened while damage on the object W with the gripping motion is suppressed. Thereby, the work efficiency by the robot 1 including the gripping device 2 may be increased. Further, the gripping motion may be performed without relying on the shape recognition of the object W by image processing, and the simplification of the configuration and the cost reduction of the robot 1 may be easily realized.

As above, the gripping device, the robot, and the control method for the gripping device according to the present disclosure are explained based on the above described embodiment and respective modified examples, however, the present disclosure is not limited to those.

For example, in the gripping device and the robot according to the present disclosure, the respective parts of the above described embodiment and respective modified examples may be replaced by arbitrary configurations having the same functions or arbitrary configurations may be added to the above described embodiment and respective modified examples. Further, the present disclosure may be a combination of two or more of the above described embodiment and respective modified examples.

What is claimed is:

1. A gripping device comprising:
a gripper gripping an object;
a pressure sensor provided in the gripper, detecting a contact force applied from the object when contacting between the gripper and the object, and outputting a detection signal;
a driver driving the gripper; and
a first controller controlling operation of the driver based on the detection signal, wherein
the first controller operates the driver in a first drive mode for decreasing a distance between the gripper and the object at a first speed when the detection signal is not output, and operates the driver in a second drive mode for decreasing the distance between the gripper and the object at a second speed lower than the first speed when the detection signal is output.

2. The gripping device according to claim 1, wherein
the first controller calculates magnitude of the contact force from the detection signal and setting the second speed based on the calculated magnitude of the contact force.

3. The gripping device according to claim 1, wherein
the first controller controls the operation of the driver by changing a waveform of a drive signal output to the driver.

4. The gripping device according to claim 1, wherein
the pressure sensor has:
a pressure-sensitive element outputting the detection signal by being pressed; and
an elastic member placed to cover the pressure-sensitive element and having a dome shape.

5. The gripping device according to claim 2, wherein
the first controller controls the operation of the driver by changing a waveform of a drive signal output to the driver.

6. The gripping device according to claim 5, wherein
the pressure sensor has:
a pressure-sensitive element outputting the detection signal by being pressed; and
an elastic member placed to cover the pressure-sensitive element and having a dome shape.

7. A robot comprising:
the gripping device according to claim 1;
a robot arm to which the gripper is attached; and
a second controller controlling operation of the robot arm.

8. The robot according to claim 7, further comprising an imager imaging the object, wherein
the second controller calculates a position of the object from an image acquired by the imager, and calculating a trajectory in which the gripper is moved based on the position of the object and a position of the gripper.

9. A control method for a gripping device including a gripper gripping an object by decreasing a distance to the object, a pressure sensor provided in the gripper, detecting a contact force applied from the object in contact with the object, and outputting a detection signal, and a driver driving the gripper,
the method comprising:
operating the driver in a first drive mode for decreasing the distance at a first speed when the detection signal is not output; and
operating the driver in a second drive mode for decreasing the distance at a second speed lower than the first speed when the detection signal is output.
